(19) United States
(12) Patent Application Publication
(10) Pub. No.: US 2002/0176660 A1
(43) Pub. Date: Nov. 28, 2002

(54) Optical wavelength multiplexer/demultiplexer and use method thereof

(75) Inventors: Tsunetoshi Saito, Tokyo (JP); Kanji Tanaka, Tokyo (JP); Kazuhisa Kashihara, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/145,123

(22) Filed: May 15, 2002

(30) Foreign Application Priority Data
May 15, 2001 (JP) 2001-145100

(51) Int. Cl. G02B 6/293; G02B 6/26

(52) U.S. Cl. 385/24; 385/42; 385/39

(57) ABSTRACT

While an arrangement is provided in which at least one stage of a Mach-Zehnder optical interferometer optical multiplexing/demultiplexing circuit (8) is connected, at least two optical output waveguides (6) are provided at a final stage. Each of the optical multiplexing/demultiplexing circuits contains a first optical waveguide (3); a second optical waveguide (4); and a plurality of directional coupling portions (1, 2) formed in such a manner that the first optical waveguide (3) is provided in proximity to the second optical waveguide (4). Optical transmission filters (7) are provided in the respective optical output waveguides (6) of the final stage, while the optical transmission filters (7) transmit therethrough light having setting wavelengths which are determined in correspondence with the respective optical output waveguide (6).

### BACKGROUND OF THE INVENTION

Very recently, as a method for considerably increasing transmission capacities in optical communications, wavelength division multiplexing (WDM) transmission techniques have been positively developed and popularized. This wavelength division multiplexing transmission technique corresponds to such a technique capable of multiplexing a plurality of optical signals having different wavelengths with each other to transmit the multiplexed-optical signal via a single optical fiber. The wavelength division multiplexing transmission technique may expand a transmission capacity by a total number of multiplexed wavelengths, and thus, may effectively increase the transmission capacity. Currently, such a wavelength division multiplexing transmission system is practically utilized, while 100, or more wavelengths are used for a long distance transmission purpose.

Also, on the other hand, wavelength division multiplexing transmission systems are also applied to such small-scaled networks as a metropolitan system and an access system. As optical components applied to such wavelength division multiplexing transmission systems, more inexpensive optical components are required.

Optical wavelength multiplexers/demultiplexers may constitute one of optical components which play an important role in wavelength division multiplexing transmission systems. An optical wavelength multiplexer/demultiplexer generally involves both an optical wavelength multiplexer and an optical wavelength demulti4plexer. Most of the optical wavelength multiplexer and most of the optical wavelength demultiplexer may have the other function (counter function) thereof.

There are various structures of optical wavelength multiplexers/demultiplexers. For instance, the below-mentioned various optical wavelength multiplexers/demultiplexers have been practically utilized, for example, optical waveguide type optical wavelength demultiplexers, optical fiber type optical wavelength multiplexers/demultiplexers, bulk type optical wavelength multiplexers/demultiplexers using transmission/reflection characteristics of thin-film filters, and the like are practically used.

Among these optical wavelength multiplexers/demultiplexers, since high-precision patterning techniques which have been developed in semiconductor fields can be applied to optical waveguide type optical wavelength multiplexers/demultiplexers, superior designing characteristics of these optical waveguide type optical wavelength multiplexers/demultiplexers may be expected. Also, since such a technique capable of forming glass films on a substrate in a batch manner can be applied to optical waveguide type optical wavelength multiplexers/demultiplexers, better mass production characteristics thereof may be expected. As these optical waveguide type optical wavelength multiplexer/demultiplexers, for example, such optical wavelength multiplexers/demultiplexers as arrayed waveguide type gratings and Mach-Zehnder interferometer (MZI) type optical wavelength multiplexers/demultiplexers have been practically available.

The following features are known as to the above-explained Mach-Zehnder interferometer type optical wavelength multiplexers/demultiplexers. That is, there is a small manufacturing fluctuation, and wavelengths can be multiplexed/demultiplexed with low transmission loss. These features are described in, for example, Japanese Laid-open Patent Application No. Sho-61-80109.

A Mach-Zehnder interferometer type optical wavelength multiplexer/demultiplexer contains, for example, such a Mach-Zehnder interferometer type optical multiplexing/demultiplexing circuit 8 shown in FIG. 8. This optical multiplexing/demultiplexing circuit 8 includes s first optical waveguide 3, and a second optical waveguide 4 arranged side by side with respect to the first optical waveguide 3. Also, the optical multiplexing/demultiplexing circuit 8 owns two sets of directional coupling portions 1 and 2 formed in such a manner that the first optical waveguide 3 is provided in proximity to the second optical waveguide 4 at a position in an interval along a longitudinal direction of the first and second optical waveguides. Both the first optical waveguide 3 and the second optical waveguide 4, which are sandwiched between the adjacent directional coupling portions 1 and 2, own different lengths from each other.

It should be noted that in the Mach-Zehnder interferometer type optical multiplexing/demultiplexing circuit 8, generally speaking, the below-mentioned path of light is called as a “through transmission path.” In other words, such a through transmission path corresponds to a path of light which is entered from a light incident side 13 of the first optical waveguide 3 and then is outputted from a light projection side 23 of this first optical waveguide 3, or another path of light which is entered from a light incident side 14 of the second optical waveguide 4 and then is outputted from a light projection side 24 of this second optical waveguide 4. In FIG. 8, a wavelength “λ1” is transmitted via the through transmission path.

Also, in the Mach-Zehnder interferometer type optical multiplexing/demultiplexing circuit 8, generally speaking, the below-mentioned path of light is called as a “cross transmission path.” In other word, such a cross transmission path corresponds to a path of light which is entered from the light incident side 13 of the first optical waveguide 3 and then is outputted from the light projection side 24 of the second optical waveguide 4, or another path of light which is entered from the light incident side 14 of the second optical waveguide 4 and then is outputted from the light projection side 23 of the first optical waveguide 3. In FIG. 8, a wavelength “λ2” is transmitted via the through transmission path.

In order to multiplex lights having different wavelengths and demultiplex light having different wavelengths from each other, the optical multiplexing/demultiplexing circuit 8 is set as follows: That is, this optical multiplexing/demultiplexing circuit 8 is properly set in such a manner that such a product (n×ΔL) made of both a difference “ΔL” between a length of the first optical waveguide 3 and a length of the second optical waveguide 4, which are sandwiched between both the first directional coupling portion 1 and the second directional coupling portion 2, and also effective refractive indexes “n” of the first and second optical waveguides 3 and 4 can substantially satisfy the below-mentioned (1) to (3):

ΔL=λ1·λ2/(2n·Δλ) (1)

n·ΔL=λ2·N (2)

n·ΔL=λ1·(N±0.5) (3)

It should also be noted that Δλ=λ2−λ1, and no definition is made as to a large/small relationship between λ1 and λ2.

Also, symbol “N” indicates an integer larger than, or equal to 1. Since a plurality of differences “ΔL” may be determined with respect to different integers “N”, transmission wavelength characteristics of both the through transmission path and the cross transmission path may become periodic. For example, as represented in FIG. 9, a wavelength period of the through transmission path indicated in a characteristic line “a” and a wavelength period of the cross transmission path shown in a characteristic line “b” are different from each other.

Also, in both the through transmission path and the cross transmission path, for example, as represented in FIG. 9, such an interval of adjacent transmission wavelengths (transmission wavelength period) [λ_{(N)}−λ_{(N+1)}] is referred to as an FSR (free spectrum range).

In the optical multiplexing/demultiplexing circuit 8 shown in FIG. 8, for instance, in such a case that signal lights having two wavelengths of “λ1”=1549 nm and “λ2”=1551 nm are multiplexed, or multiplexed signal light is demultiplexed, any of the first directional coupling portion 1 and the second directional coupling portion 2 are designed in such a manner that any of these first and second directional coupling portions 1 and 2 may have a power coupling ratio of approximately 50% (for example, within 50%+1 and 50%−1) with respect to both the signal lights having the wavelengths of λ1 and λ2.

Also, in the case of a silica-based optical waveguide having an effective refractive index n=approximately 1.45, when the wavelength λ1=1549 nm and the wavelength λ2 =1551 nm, if the difference “ΔL” is equal to 417 m, all of formulae (1) to (3) can be satisfied at the same time.

In the optical multiplexing/demultiplexing circuit 8 shown in FIG. 8, since the power coupling ratio and the dimension of the difference “ΔL” are formed with respect to the wavelength λ1 and λ2 of the directional coupling portions 1 and 2 in the above-explained manner, the following effects may be achieved. That is to say, for instance, when both the light having the wavelength of λ1 and the light having the wavelength of λ2 are simultaneously entered from any one of the first optical waveguide 3 and the second optical waveguide 4, the lights having these wavelengths can be separately outputted from the first optical waveguide 3 and the second optical waveguide 4. Conversely, when the light having the wavelength of λ1 is entered into the first optical waveguide 3 and the light having the wavelength of λ2 is entered into the second optical waveguide 4, two sets of the light having these wavelengths can be multiplexed with each other to output the multiplexed light.

Also, for instance, as shown in FIG. 10, when such an optical wavelength multiplexer/demultiplexer is constituted, this optical wavelength multiplexer/demultiplexer capable of multiplexing/demultiplexing a larger number of optical signals may be realized. That is, this optical wavelength multiplexer/demultiplexer is manufactured in such a way that such a circuit is formed on a substrate, in which plural stages (two stages in this case) of the above-described optical multiplexing/demultiplexing circuits 8(8A, 8B, 8C) with the different FSRs from each other are connected to each other.

In the optical wavelength multiplexer/demultiplexer shown in FIG. 10, both the light of the wavelength λ1 and the light of the wavelength λ3 are multiplexed with each other by the optical multiplexing/demultiplexing circuit 8(8B), and then, the multiplexed light is transmitted to the optical multiplexing/demultiplexing circuit 8(8A). Also, the light of the wavelength λ4 and the light of the wavelength λ2 are multiplexed with each other by the optical multiplexing/demultiplexing circuit 8(8C), and then, the multiplexed light is transmitted to the optical multiplexing/demultiplexing circuit 8(8A). Then, the lights of the wavelengths λ1, λ3, λ4, and λ2 are multiplexed with each other by the optical multiplexing/demultiplexing circuit 8(8A). This multiplexed light is outputted from the optical output waveguide 6.

As previously explained, the optical wavelength multiplexer/demultiplexer shown in FIG. 10 may function as such an optical wavelength multiplexer capable of multiplexing the four wavelengths of λ1, λ2, λ3, and λ4. In this case, while the FSR of the first stage of the optical multiplexing/demultiplexing circuits 8(BB, 8C) is selected to be 1600 GHz, and also, the FSR of the second stage of the optical multiplexing/demultiplexing circuit 8(8A) is selected to be 800 GHz, each of these optical multiplexing/demultiplexing circuits 8(8A, 8B, 8C) is formed. As a result, the optical wavelength multiplexer/demultiplexer can multiplex such lights having the wavelengths of λ1, λ2, λ3, λ4 with a frequency interval of 400 GHz (wavelength interval of approximately 3.2 nm in 1550 nm).

FIG. 11 represents an optical transmission wavelength characteristic of such light which is inputted from an optical input waveguide 5a, and then, is outputted from an optical output waveguide 6 employed in the optical wavelength multiplexer/demultiplexer shown in FIG. 10. Also, characteristic lines “a”, “b”, “c”, and “d” of FIG. 12 represent optical transmission wavelength characteristics of such light which is entered from the respective optical input waveguides 5a, 5b, 5c, 5d, and is outputted from the optical output waveguide 6 employed in the optical wavelength multiplexer/demultiplexer shown in FIG. 10, respectively.

As indicated in FIG. 11 and FIG. 12, in such a case that the four wavelengths of λ1, λ2, λ3, λ4 are multiplexed with each other in the optical wavelength multiplexer/demultiplexer shown in FIG. 10, an insertion loss of each of the optical transmission center wavelengths is very low, namely is nearly equal to 1 dB. This optical wavelength multiplexer/demultiplexer may have a superior optical multiplexing characteristic.

Also, a chip size of this optical wavelength multiplexer/demultiplexer is nearly equal to 5 mm 50 mm, namely very small. As a consequence, this optical wavelength multiplexer/demultiplexer may be highly expected as such an optical wavelength multiplexer/demultiplexer used in a wavelength division multiplexing transmission system having a small number of channels such as the above-described metropolitan system and access system, while superior cost performance thereof can be maintained.

### SUMMARY OF THE INVENTION

The present invention is to provide an optical wavelength multiplexer/demultiplexer having the below-mentioned structures and a use method of this optical wavelength multiplexer/demultiplexer.

An optical wavelength multiplexer/demultiplexer, according to the present invention, is featured by comprising:

an optical multiplexing/demultiplexing circuit of a Mach-Zehnder optical interferometer which is connected in at least one stage; wherein:

said optical multiplexing/demultiplexing circuit of one Mach-Zehnder optical interferometer is comprised of:

a first optical waveguide;

a second optical waveguide arranged side by side with respect to said first optical waveguide; and

a plurality of directional coupling portions formed in such a manner that said first optical waveguide is provided in proximity to said second optical waveguide at a position in an interval along a longitudinal direction of said first and second optical waveguides;

both the first optical waveguide and the second optical waveguide, which are sandwiched between the adjacent directional coupling portions, own different lengths from each other;

a final stage of said optical multiplexing/demultiplexing circuit of the Mach-Zehnder optical interferometer connected in at least one stage owns at least two optical output waveguides; and

optical transmission filters are provided in the respective optical output waveguides of the final stage, while said optical transmission filters penetrate therethrough light having setting wavelengths which are determined in correspondence with the respective optical output waveguides.

### BRIEF DESCRIPTION OF THE DRAWINGS

Exemplary embodiments of the invention will now be described in conjunction with drawings, in which;

FIG. 1A is an essential-part structural view for indicating an optical wavelength multiplexer/demultiplexer according to a first embodiment of the present invention by way of a plan view;

FIG. 1B is a side view for representing an essential structure of the above-described first embodiment;

FIG. 2 is a graph for graphically indicating an optical transmission characteristic of one optical transmission filter which is applied to the optical wavelength multiplexer/demultiplexer of the first embodiment;

FIG. 3 is a graph for graphically showing a transmission spectrum of light which is inputted from an optical input waveguide and is outputted from one optical output waveguide of the first embodiment;

FIG. 4A is an essential-part structural view for indicating an optical wavelength multiplexer/demultiplexer according to a second embodiment of the present invention;

FIG. 4B is an explanatory view for explaining arranging conditions of optical transmission filters in the second embodiment;

FIG. 5 is an essential-part structural view for indicating an optical wavelength multiplexer/demultiplexer according to a third embodiment of the present invention;

FIG. 6 is an essential-part structural view for indicating an optical wavelength multiplexer/demultiplexer according to another embodiment of the present invention;

FIG. 7A and FIG. 7B are explanatory views for indicating an example of optical multiplexing/demultiplexing circuits which are applied to an optical wavelength multiplexer/demultiplexer according to a further embodiment of the present invention;

FIG. 8 is an explanatory view for representing a Mach-Zehnder optical interferometer type optical multiplexing/demultiplexing circuit;

FIG. 9 is a graph for graphically indicating an optical transmission characteristic as to both a through transmission path and a cross transmission path of the Mach-Zehnder optical interferometer type optical multiplexing/demultiplexing circuit shown in FIG. 8;

FIG. 10 is an explanatory view for explaining an optical multiplexing circuit manufactured in such a manner that plural stages of Mach-Zehnder optical interferometer type optical multiplexing/demultiplexing circuits are connected to each other;

FIG. 11 is a graph for graphically showing a transmission spectrum of light which is inputted from an optical input waveguide and is outputted from one optical output waveguide of the circuit shown in FIG. 10;

FIG. 12 is a graph for graphically showing a transmission spectrum of the circuit indicated in FIG. 10; and

FIG. 13 is an explanatory view for explaining an optical demultiplexing circuit manufactured in such a manner that plural stages of Mach-Zehnder optical interferometer type optical multiplexing/demultiplexing circuits are connected to each other.

### DETAILED DESCRIPTION

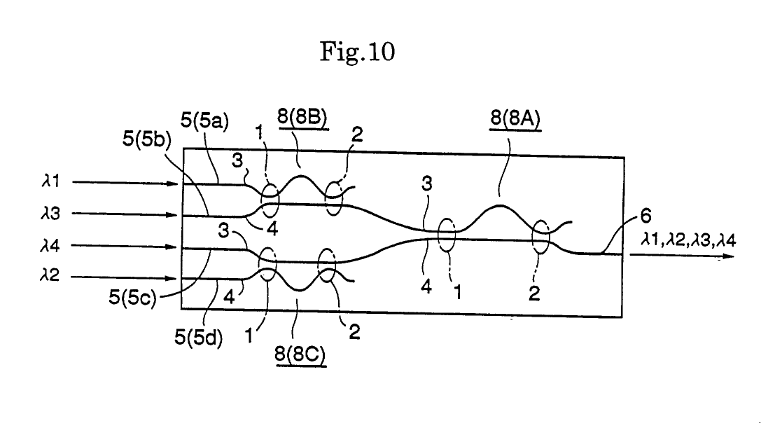

As previously explained, the optical wavelength multiplexer/demultiplexer shown in FIG. 10 owns the superior optical multiplexing characteristic. In the case that this optical wavelength multiplexer/demultiplexer is used as an optical wavelength demultiplexer, there is a certain possibility that the required characteristic thereof cannot be satisfied. In other words, in the case that the optical wavelength multiplexer/demultiplexer shown in FIG. 10 demultiplexes such wavelength-multiplexed light having a plurality of wavelengths into plural lights having respective wavelengths, there is a certain possibility that crosstalk of light from other channels may become larger than a value required for the wavelength demultiplexer.

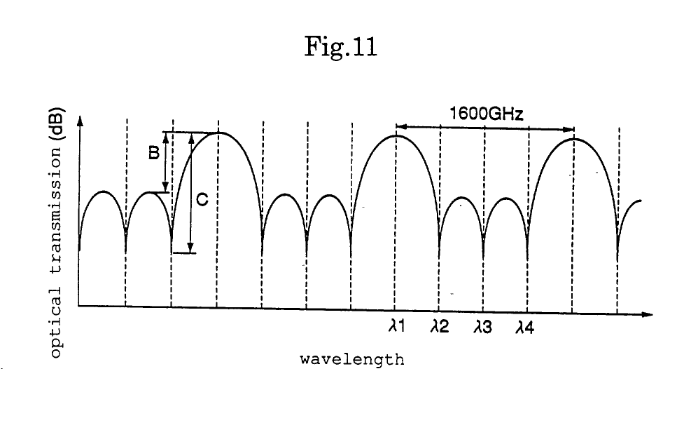

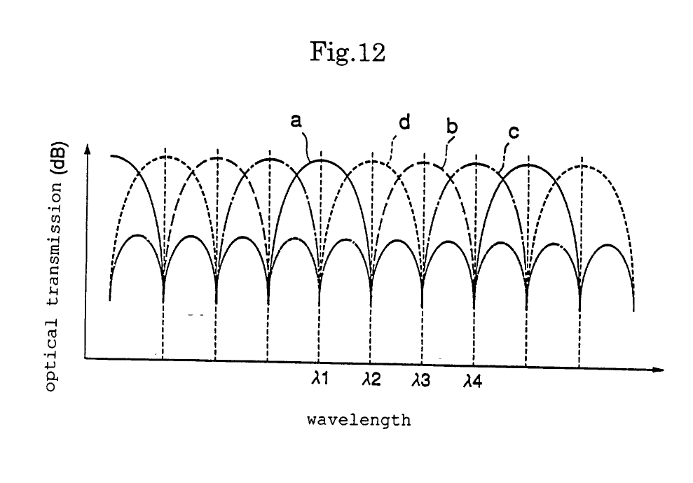

In the optical wavelength multiplexer/demultiplexer of FIG. 10, values equivalent to the above-described crosstalk are, for example, such values indicated in “B” and “C” of FIG. 11, in which “B” is nearly equal to −10 dB, and “C” is nearly equal to −20 dB. In contrast, since the crosstalk required for the optical wavelength demultiplexer is lower than, equal to approximately −30 dB, the above-described “B” value and “C” value are very large, as compared with the required value of the crosstalk.

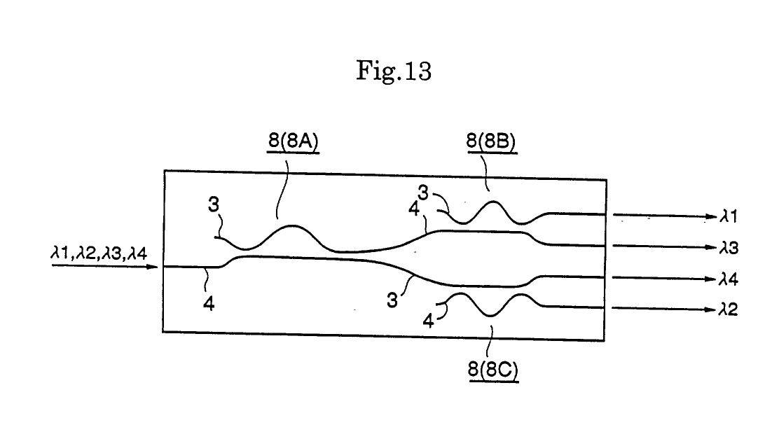

As a consequence, as indicated in FIG. 13, it is practically difficult to use such an optical wavelength multiplexer/demultiplexer as a wavelength demultiplexer. That is, this optical wavelength multiplexer/demultiplexer is arranged by that plural stages of the above-explained Mach-Zehnder optical interferometer type optical multiplexing/demultiplexing circuits 8 (namely, 8A, 8B, 8C) are connected to each other. It should be understood that FIG. 13 indicates a structural example of an optical wavelength multiplexer/demultiplexer used for optical demultiplexing operation, and also a use example of this optical wavelength multiplexer/demultiplexer, while the optical wavelength multiplexer/demultiplexer shown in FIG. 10 is inverted.

One aspect of the present invention is to provide both a compact optical wavelength multiplexer/demultiplexer and a use method of this optical wavelength multiplexer/demultiplexer, while this optical wavelength multiplexer/demultiplexer is capable of multiplexing and/or demultiplexing such light having a plurality of wavelengths in low crosstalk, and is capable of being manufactured in a better mass production manner.

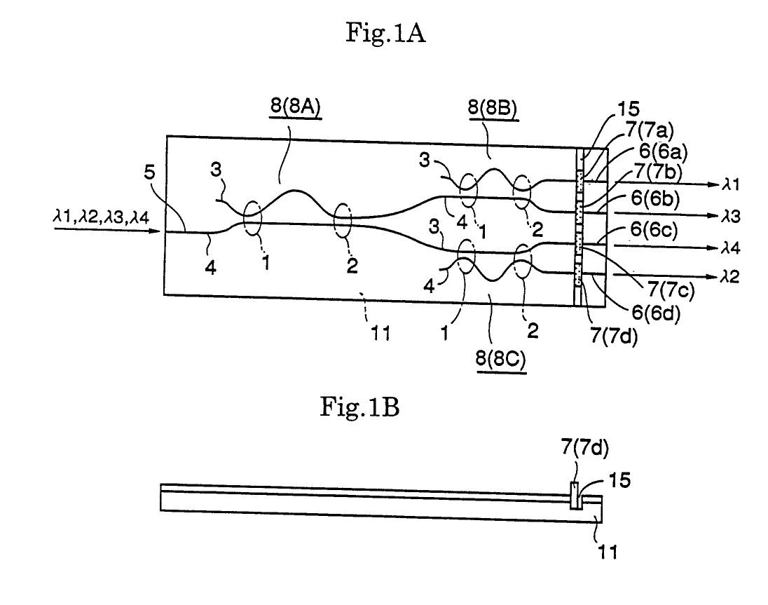

Referring now to drawings, various embodiment modes of the present invention will be described in detail. It should be understood that in descriptions of a first embodiment, the same reference numerals shown in the prior art will be employed as those for denoting the same, or similar structural elements, and explanations thereof are omitted, or will be simply made. In FIG. 1A, an essential-part structural view of an optical wavelength multiplexer/demultiplexer according to a first embodiment of the present invention is indicated as a plan view. FIG. 1B shows a side view of the optical wavelength multiplexer/demultiplexer of FIG. 1A.

As shown in FIG. 1A, the optical wavelength multiplexer/demultiplexer of this first embodiment is formed in such a manner that at least one stage of Mach-Zehnder optical interferometer type optical multiplexing/demultiplexing circuit 8 (8A, 8B, 8C) is connected (in this example, two stages). In this optical wavelength multiplexer/demultiplexer, at least two sets of optical output waveguides 6(6a to 6d) are provided at a final stage thereof (in this example, four sets).

The optical wavelength multiplexer/demultiplexer of the first embodiment is constructed in such a manner that optical transmission filters 7(7a to 7d) are provided on the optical output waveguides 6(6a to 6d) of the respective final stages. Each of these optical transmission filters 7(7a to 7d) corresponds to each of such filters (bandpass filters) which transmits light having wavelengths set in correspondence with the respective optical output waveguides 6(6a to 6d).

The optical multiplexing/demultiplexing circuits 8(8A, 8B, 8C) are formed on a substrate 11. While a slit groove 15 is formed in this substrate 11 along a direction across the optical output waveguides 6(6a to 6d), the optical transmission filters 7(7a to 7d) are inserted into this slit groove 15. The slit groove 15 is formed in such a manner that the substrate 11 is cut by using a dicing saw having a width of, for example, 25 micrometers. The optical transmission filters 7(7a to 7d) are fixed by using such adhesive whose diffractive index is matched with the diffractive indexes of the optical output waveguides 6(6a to 6d).

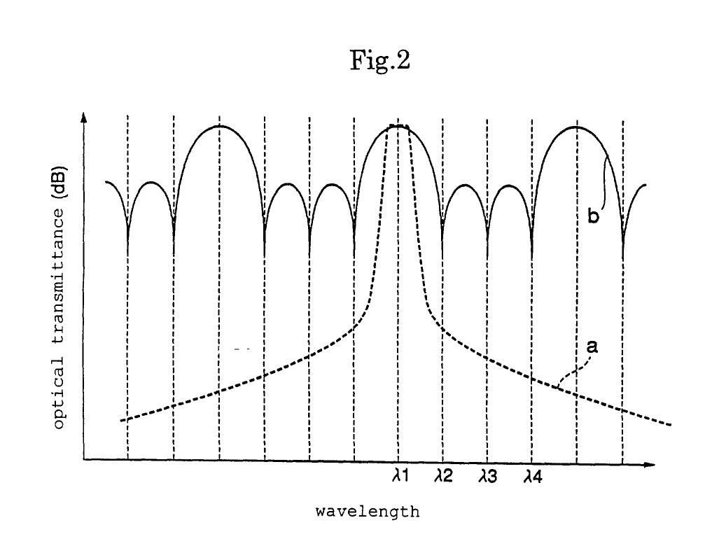

Each of the optical transmission filters 7(7a to 7d) is formed by a dielectric multilayer film filter having a thickness of approximately 20 m including a polyimide base plate, while polyimide is employed as a base plate. A characteristic line “a” of FIG. 2 shows an optical transmission wavelength characteristic of the optical transmission filter 7a. As indicated in this characteristic line “a”, the optical transmission filter 7a may transmit therethrough such a light having a setting wavelength which is determined in correspondence with the optical output waveguide 6a, namely the setting wavelength in which a wavelength “λ1” is located as a center. Since the optical transmission range of the optical transmission filter 7a is approximately 200 GHz, this optical transmission filter 7a may have a sufficiently wide optical transmission range with respect to signal light.

It should be noted that another characteristic line “b” of FIG. 2 represents such an optical transmission wavelength characteristic of light which is inputted from the optical input waveguide 5 and then is outputted from the optical output waveguide 6a in such a case that the optical transmission filter 7a is not provided with the optical output waveguide 6a. This characteristic line “b” is the same as the characteristic line shown in FIG. 11.

Also, in this first embodiment, the optical transmission filter 7b may transmit therethrough such a light that a wavelength “λ3” is located as a center. Also, the optical transmission filter 7c may penetrate therethrough such a light that a wavelength “λ4” is located as a center. Also, the optical transmission filter 7d may transmit therethrough such a light that a wavelength “λ2” is located as a center. The above-described wavelength λ3 is such a setting wavelength of light which is determined in correspondence with the optical output waveguide 6b. The above-described wavelength λ4 is such a setting wavelength of light which is determined in correspondence with the optical output waveguide 6c. The above-described wavelength λ2 is such a setting wavelength of light which is determined in correspondence with the optical output waveguide 6d.

With respect to each of optical transmission wavelength characteristics of the optical transmission filters 7b, 7c, 7d, the respective optical transmission center wavelengths are λ3, λ4, λ2 in the mode shown in the characteristic line “a” of FIG. 2, and also, each of optical transmission ranges thereof is nearly equal to 200 GHz.

It should be understood that in the first embodiment, any of the above-described wavelengths λ1, λ2, λ3, λ4, is matched with the grid wavelength of ITU-T. That is to say, λ1=1538.186 nm (194.9 THz), λ2=1541.349 nm (194.5 THz), λ3=1544.526 nm (194.1 THz), and λ4=1547.715 nm (193.7 THz). A frequency interval between adjoining wavelengths among these wavelengths is equal to 400 GHz.

As previously explained, in the first embodiment, since the frequency interval (channel spacing) of the wavelengths λ1, λ2, λ3, λ4, are selected to be 400 GHz, a frequency interval of adjoining channels of the above-described optical transmission filters 7(7a to 7d) is also selected to be 400 GHz. As described above, since the frequency interval of the adjoining channels of the optical transmission filters 7(7a to 7d) is wide, these optical transmission filters 7(7a to 7d) can be designed and manufactured without paying a specific attention to such a fact that a skirt portion of an optical transmission spectrum specific to a dielectric multilayer film is widened. Therefore, while the optical transmission filters 7(7a to 7d) can be designed and also manufactured in an easy manner, there is a merit that these optical transmission filters 7(7a to 7d) can be manufactured in low cost and is a mass production manner.

The optical wavelength multiplexer/demultiplexer of the first embodiment is constituted in such a manner that while a circuit chip having the structures shown in FIG. 1A and FIG. 1B is stored in a package (not shown), corresponding optical fibers (not shown) are connected to the optical input waveguide 5 and the respective optical output waveguides 6(6a to 6d). It should also be noted that the optical fibers are normally held by an optical fiber array.

While the optical wavelength multiplexer/demultiplexer of the first embodiment is arranged with employment of the above-described structures, a use example will now be explained in which this optical wavelength multiplexer/demultiplexer of the first embodiment is used as an optical demultiplexer. In this use example case, such a wavelength-multiplexed light which owns a plurality of wavelengths (λ1, λ2, λ3, λ4) different from each other and is entered from a single set of optical input waveguide 5 is demultiplexed by the respective optical multiplexing/demultiplexing circuits 8(8A, 8B, 8C) to obtain the respective signal light wavelengths which correspond to the respective optical output waveguides 6(6a to 6d) provided at the final stage.

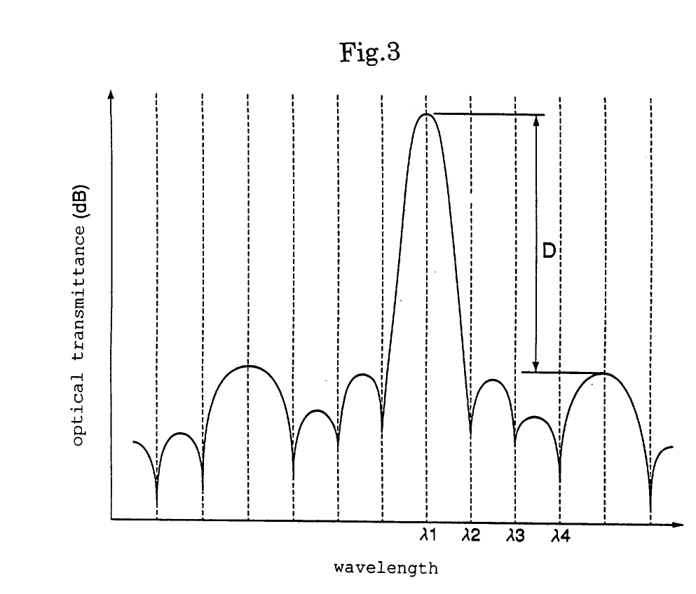

The optical wavelength multiplexer/demultiplexer of the first embodiment is arranged in such a way that the optical transmission filters 7(7a to 7d) are provided with the optical output waveguides 6(6a to 6d), and these optical transmission filters 7(7a to 7d) may transmit therethrough the light having such setting wavelengths defined in correspondence with the respective optical output waveguides 6(6a to 6d). As a consequence, for example, an optical transmission/wavelength characteristic of such a light which is inputted from the optical input waveguide 5 and then is outputted from the optical output waveguide 6a is obtained by summing the characteristic line “a” with the characteristic line “b” of FIG. 2. In other words, this optical transmission/wavelength characteristic may become such a characteristic indicated in a characteristic line of FIG. 3.

In this optical transmission wavelength characteristic, a value indicated by a symbol “D” of FIG. 3 becomes such a value corresponding to crosstalk. The value of this crosstalk indicated by the symbol “D” of FIG. 3 was nearly equal to −60 dB.

Also, in the first embodiment, optical transmission/wavelength characteristics of such light which is entered from the optical input waveguide 5 and then is outputted from the respective optical output waveguides 6b, 6c, 6d represent such shapes similar to that of the characteristic line shown in FIG. 3, while the light having the respective setting wavelengths of λ3, λ4, λ2 is set as an optical transmission center wavelength. As a consequence, these optical transmission/wavelength characteristics may become such characteristics that any value of crosstalk is nearly equal to −60 dB.

As previously explained, in accordance with the first embodiment, it is possible to realize such an optical wavelength multiplexer/demultiplexer capable of demultiplexing the light having a plurality of wavelengths under low crosstalk condition.

Also, as being realized in the first embodiment, such an arrangement can demultiplex the light having a plurality of wavelengths under low crosstalk condition. That is, in this arrangement, the optical wavelength multiplexer/demultiplexer is formed by employing the optical transmission filters 7 capable of transmitting therethrough the light having the setting wavelengths on the optical output waveguides 6 of the final stages of the Mach-Zehnder optical interferometer type optical multiplexing/demultiplexing circuits 8 connected in a plural-stage form. Then, this optical wavelength multiplexer/demultiplexer is used as an optical demultiplexer.

Also, the optical wavelength multiplexing/demultiplexing apparatus of the first embodiment is constituted by providing the optical transmission filters 7(7a to 7d) in the optical output waveguides 6(6a to 6d) of the final stage for the wavelength demultiplexing circuit which is constituted by connecting two stages of the Mach-Zehnder optical interferometer type optical multiplexing/demultiplexing circuits 8(8A, 8B, 8C). As a result, this optical wavelength multiplexing/demultiplexing apparatus can be made compact and in an easy manner, and can be manufactured in a better mass production manner.

Furthermore, in accordance with the optical multiplexing/demultiplexing circuit of the first embodiment, while the slit groove 15 is formed in the substrate 11, the optical transmission filters 7(7a to 7d) are inserted/fixed in this slit groove 5. Since the optical transmission filters 7(7a to 7d) are fixed, these optical filters 7(7a to 7d) may be provided in the optical output waveguides 6(6a to 6d) corresponding thereto.

As previously explained, in the optical wavelength multiplexer/demultiplexer of the first embodiment, such a structure is applied. That is, the slit groove 15 is formed, and the optical transmission filters 7(7a to 7d) are inserted/fixed in this slit groove 15. Since this structure is applied, a more inexpensive optical wavelength multiplexer/demultiplexer may be manufactured in a better mass production manner.

As a consequence, in particular, the optical wavelength multiplexer/demultiplexer of the first embodiment is optimally used in a small-scaled network of a wavelength division multiplexing transmission system such as a metropolitan system and an access system, which necessarily require low cost respects.

Furthermore, in the optical wavelength multiplexer/demultiplexer of the first embodiment, the optical transmission filters 7(7a to 7d) are fixed to the optical output waveguides 6(6a to 6d) by employing the adhesive whose refractive index is matched with the refractive indexes thereof. As a result, an increase of an insertion loss caused by the optical transmission filters 7(7a to 7d) is nearly equal to 0.3 to 0.5 dB, namely very small. As a consequence, the entire insertion loss of this optical wavelength multiplexer/demultiplexer according to the first embodiment is smaller than, or equal to −2.5 dB within a temperature range of 0 to 70 C., namely very good condition.

Furthermore, in the optical wavelength multiplexer/demultiplexer of the first embodiment, while the optical transmission filters are constituted by the dielectric multilayer film filters, the dielectric multilayer film filters can be designed and manufactured in the easy manner and under better mass production condition. As a result, the mass productivity of the optical wavelength multiplexer/demultiplexer can be furthermore improved.

It should also be noted that since the below-mentioned manufacturing method is applied to the optical wavelength multiplexer/demultiplexer of the first embodiment, this optical wavelength multiplexer/demultiplexer can be manufactured in a higher efficiency. This manufacturing method is given as follows. That is, while a plurality of circuits having the structures shown in FIG. 1A are formed on a single substrate 11, the slit 15 is formed. Thereafter, the resultant circuit substrate 11 is subdivided into individual circuit chips in the unit of the circuit shown in FIG. 1A. When this manufacturing method is applied, the optical wavelength multiplexer/demultiplexer may be manufactured in a higher efficiency, as compared with such a manufacturing method that the slit groove 15 is formed in each of the chips.

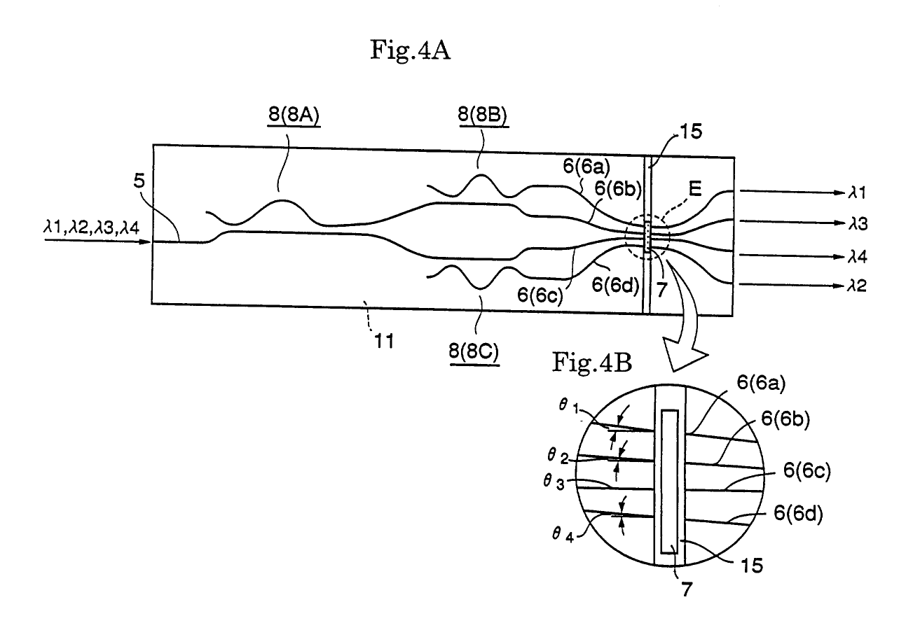

FIG. 4A shows an essential-part view of an optical wavelength multiplexer/demultiplexer according to a second embodiment of the present invention. FIG. 4B is an enlarged view for showing an area surrounded by a broken-line frame “E” shown in FIG. 4A. It should be understood that while the optical wavelength multiplexer/demultiplexer according to this second embodiment is arranged substantially identical to that of the above-explained first embodiment, the same reference numerals shown in the first embodiment will be employed as those for denoting the same, or similar structural components of the second embodiment, and thus, explanations thereof will be omitted, or will be made simple.

The optical wavelength multiplexer/demultiplex of the second embodiment is formed by providing one optical transmission filter 7 in a slit groove 15. The second embodiment is featured by that while the respective optical output waveguides 6(6a to 6d) are collected to an arranging portion of this optical transmission filter 7, intersect angles between this slit groove 15 and at least two sets (in this case, four sets) of the optical output waveguides 66a to 6d) are made different from each other.

As explained above, since the above-described intersect angles are made different from each other in this second embodiment, incident angles “θ₁”,“θ₂”, “θ₃”, and “θ₄” of such light which passes through the respective optical output waveguides 6(6a to 6d) and then is entered into the optical transmission filter 7 are made different from each other. Then, since the indent angles θ₁, θ₂, θ₃, θ₄ of the above-explained light are made different from each other, the optical wavelength multiplexer/demultiplexer according to the second embodiment is constituted by that the optical transmission filter 7 may transmit therethrough the light having the respective setting wavelengths at the intersect portions with respect to the respective optical output waveguides 6(6a to 6d).

A filter using multiple beam interference such as a dielectric multilayer film filter is featured by that since thicknesses among the respective films for constituting this filter may constitute a very important parameter as to a transmission wavelength and a reflection wavelength, when an insertion angle of light is changed, an effective film thickness is changed and therefore a wavelength dependent characteristic is changed. As a result, as previously explained, since the incident angles θ₁, θ₂, θ₃, θ₄ of the light entered into the optical transmission filter 7 are made different from other, the optical transmission filter 7 may transmit therethrough the light having the respective setting wavelengths at the intersect portions with respect to the respective optical output waveguides 6(6a to 6d).

It should also be noted that the optical transmission filter 7 made of the dielectric multilayer film filter which has been applied to the second embodiment owns such a characteristic. That is, assuming now that an incident angle of light entered into the optical transmission filter 7 is selected to be “x”, and a shift amount of a center wavelength on the side of a short wavelength is selected to be “y”, this optical transmission filter 7 can be approximated by y=0.1 x².

In the second embodiment, θ₁=4.9 degrees;θ₂=2.8 degrees; θ₃=0 degree; and θ₄=4.0 degrees. With employment of this construction, optical transmission center wavelengths of “λ1” to “λ4” are such values which are shifted by approximately 0.8 nm (100 GHz) on the side of short wavelengths in this order of μ3, μ2, and λ1, while the output wavelength of “λ4” derived from the optical output waveguide 6(6c) is used as a reference.

The optical wavelength multiplexer/demultiplexer of the second embodiment corresponds to such an optical wavelength demultiplexing circuit whose channel spacing is 100 GHz. In the second embodiment, λ1=1545.322 nm (194.0 THz), λ2=1546.119 nm (193.9 THz), λ3=1546.917 nm (193.8 THz), and λ4=1547.715 nm (193.7 THz).

In the second embodiment, one sheet of such an optical transmission filter 7 may transmit therethrough the light having the setting wavelengths of λ1, λ3, λ4, λ2, which are determined in correspondence with the respective optical output waveguides 6(6a to 6d) at the intersect portion between this optical transmission filter 7 and the respective optical output waveguides 6(6a to 6c).

Since the optical wavelength multiplexer/demultiplexer of the second embodiment is constructed in the above-explained manner, this second embodiment can also achieve a similar effect to that of the first embodiment.

In accordance with the second embodiment, such one optical transmission filter 7 can transmit therethrough the light having the above-described setting wavelengths at the intersect portion between this optical transmission filter 7 and the respective optical output waveguides 6(6a to 6c). As a consequence, a total number of these optical transmission filters 7 can be reduced, so that the optical wavelength multiplexer/demultiplexer can be manufactured in more inexpensive cost.

As is well known in this technical field, when an incident angle of light entered into such a filter as the optical transmission filter 7 is increased, the following fact is known. That is, a spectrum of an optical transmission characteristic of this filter would be distorted. It should be noted that since the above-explained incident angle of the light is set to be smaller than, or equal to 5 degrees in the second embodiment, the spectrum distortion is very small, and may be essentially neglected.

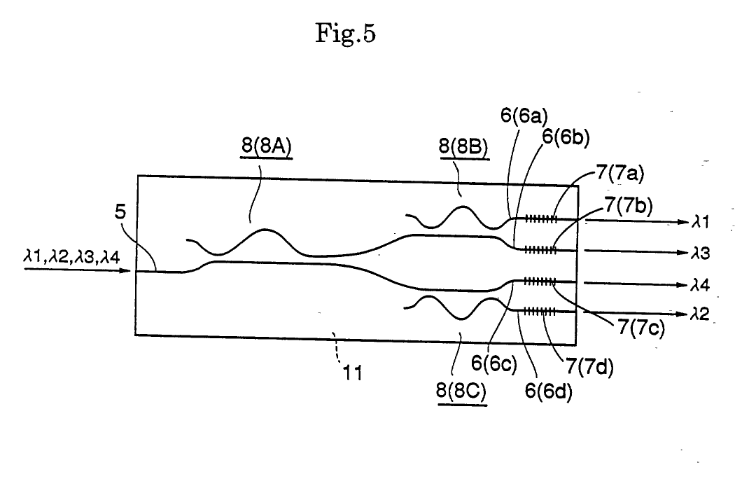

FIG. 5 shows an essential-part plane view of an optical wavelength multiplexer/demultiplexer according to a third embodiment of the present invention. It should be understood that while the optical wavelength multiplexer/demultiplexer according to this third embodiment is arranged substantially identical to that of the above-explained first embodiment, the same reference numerals shown in the first embodiment will be employed as those for denoting the same, or similar structural component of the third embodiment, and thus, explanations thereof will be omitted, or will be made simple.

A difference structure of this third embodiment from the first embodiment is such that optical transmission filters 7(7a to 7d) are fabricated by gratings. A grating corresponds to a grid-shaped wavelength filter in which areas having different diffractive indexes are formed in a periodic manner.

Since each of the optical transmission filters 7(7a to 7d) is arranged by forming such a grating having the below-mentioned structure, as indicated in FIG. 5, these optical transmission filters 7(7a to 7d) may transmit therethrough the light having the above-explained setting wavelengths λ1, λ3, λ4, and λ2. The grating is arranged in such a manner that both wavelengths located on the long wavelength side and also wavelengths located on the short wavelength side with respect to the setting wavelengths (optical transmission wavelength) which are determined in correspondence with the respective optical output waveguides 6(6a to 6d) may be reflected, or may be escaped to a cladding.

It should also be noted that the forming method of this grating is not limited to a specific forming method, but may be properly set. In the third embodiment, the grating was manufactured by applying such a phase mask method used to form a fiber Bragg grating. In other words, in this third embodiment, while the phase mask method is applied, ultraviolet rays were penetrated via the phase mask, so that interference fringes were manufactured on the optical output waveguides 6(6a to 6d).

Since the optical wavelength multiplexer/demultiplexer of the third embodiment is constructed in the above-explained manner, this third embodiment can also achieve a similar effect to that of the first and second embodiments.

In accordance with the third embodiment, such a slit groove 15 for inserting thereinto the dielectric multi-film filter as explained in the above-described first and second embodiments is no longer required. As a consequence, the optical wavelength multiplexer/demultiplexer of this third embodiment can be made more compact. Also, while the increase of the insertion loss caused by forming the slit groove 15 can be suppressed, the optical wavelength multiplexer/demultiplexer according to the third embodiment, the insertion loss of which can be further lowered, can be realized.

It should be understood that the present invention is not limited to the above-explained respective embodiments, but may be realized by way of various preferred embodiments. For example, in each of the above-described first to third embodiments, while two stages of the three optical multiplexing/demultiplexing circuits 8(8A, 8B, 8C) are connected, the optical wavelength multiplexer/demultiplexer has been formed. However, a total number and also a total stage of these optical multiplexing/demultiplexing circuits 8 which form the optical wavelength multiplexer/demultiplexer of the present invention are not restricted to specific numbers, but may be properly selected.

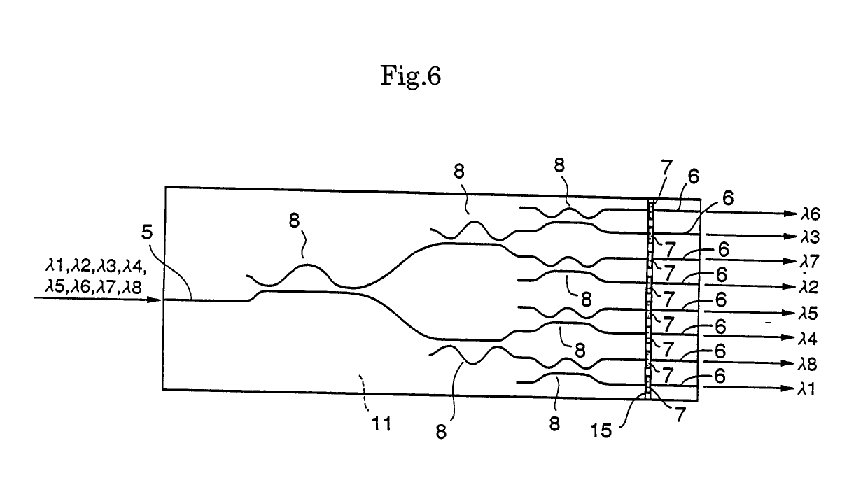

For instance, as represented in FIG. 6, the optical wavelength multiplexer/demultiplexer of the present invention may be realized by constructing such an optical wavelength multiplexer/demultiplexer in such a way that seven sets of the optical multiplexing/demultiplexing circuits 8 are connected to each other in three stages. Alternatively, the optical wavelength multiplexer/demultiplexer of the present invention may be realized by constituting such an optical wavelength multiplexer/demultiplexer having one stage (one set) of such an optical multiplexing/demultiplexing circuit 8.

Furthermore, in the above-described first and second embodiments, the channel spacing of the optical wavelength multiplexer/demultiplexer is set to 400 GHz, whereas the channel spacing of the optical wavelength multiplexer/demultiplexer is set to 100 GHz in the second embodiment. However, the channel spacing of the optical wavelength multiplexer/demultiplexer is not specifically limited, but may be properly set, for instance, 200 GHz.

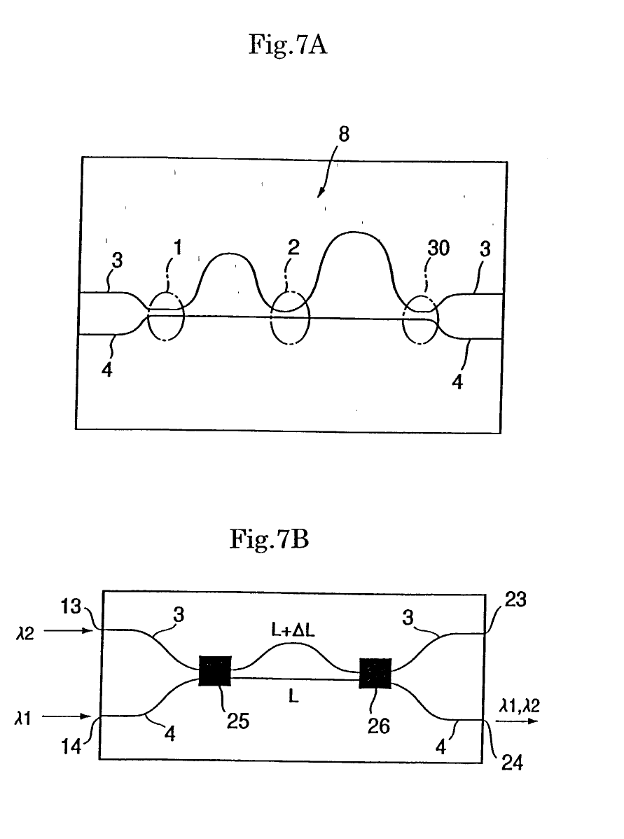

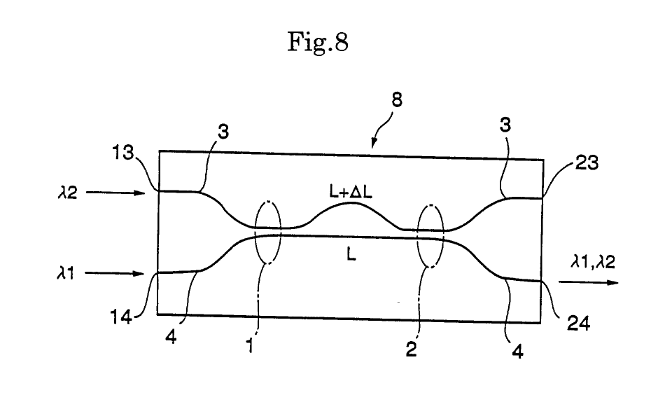

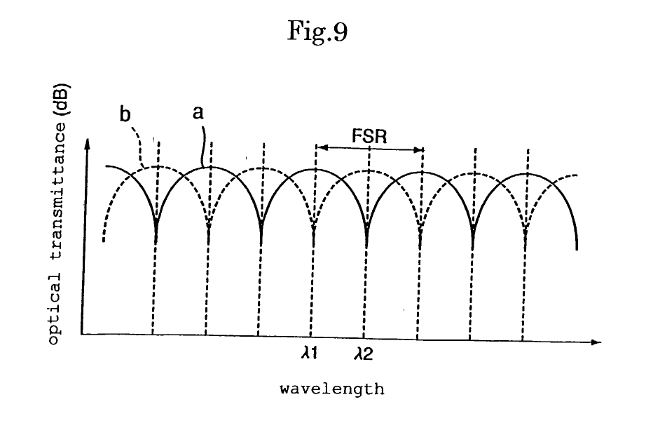

Furthermore, in the above-described respective embodiments, the Mach-Zehnder optical interferometer type optical multiplexing/demultiplexing circuit 8 which constructs the optical wavelength multiplexer/demultiplexer is arranged as such a circuit having two sets of directional coupling portions 1 and 2. However, the Mach-Zehnder type optical interferometer type optical multiplexing/demultiplexing circuit 8 may be alternatively realized as such a circuit having more than three directional coupling portions, for example, as indicated in FIG. 7A. Namely, in this alternative case, three sets of directional coupling portions 1, 2, and 30 are employed.

Also, as indicated in FIG. 7B, instead of at least one of the directional coupling portions, the optical multiplexing/demultiplexing circuit 8 may be realized as such a circuit that multi-mode optical interference waveguides 25 and 26 are provided.

As previously explained, in the optical wavelength multiplexer/demultiplexer of the present invention, the multi-mode optical interference waveguides are provided instead of at least one of the directional coupling portions, so that the manufacturing error of the optical multiplexing/demultiplexing circuit can be reduced, and the yield thereof can be improved.

Furthermore, the above-described respective embodiments have been exemplified by that the optical wavelength multiplexer/demultiplexer is used as the optical wavelength demultiplexer. Alternatively, since the optical wavelength multiplexer/demultiplexer of the present invention owns the reciprocity characteristic of the optical circuit, for instance, the following use method may be applied thereto. That is, while a plurality of light having a plurality of wavelengths different from each other are entered from a plurality of optical output waveguides 6 so as to be multiplexed with each other, the multiplexed light may be outputted from one optical input waveguide 5.

As previously described, the construction for using the optical wavelength multiplexer/demultiplexer of the present invention in the multiplexing operation may multiplex such light having a plurality of wavelengths with each other in low crosstalk.

What is claimed is:

1. An optical wavelength multiplexer/demultiplexer comprising:
an optical multiplexing/demultiplexing circuit that includes a Mach-Zehnder optical interferometer, said Mach-Zehnder optical interferometer being at least one stage and having a final stage, and including
a first optical waveguide,
a second optical waveguide arranged side-by-side with respect to said first optical waveguide, and
a plurality of directional coupling portions respectively formed where a portion of said first optical waveguide is located adjacent to and in proximity to a portion of said second optical waveguide for a predetermined interval along a longitudinal direction of both said first and second optical waveguides,
respective segments of the first optical waveguide and the second optical waveguide that are sandwiched between adjacent directional coupling portions having different lengths, the final stage having
at least two optical output waveguides, and
optical transmission filters provided in respective of the at least two optical output waveguides, said optical transmission filters being configured to transmit therethrough light having setting wavelengths determined in correspondence with wavelengths passed by the respective optical output waveguides.

2. An optical wavelength multiplexer/demultiplexer according to claim 1 wherein:
at least one of said optical transmission filters is a dielectric multilayer filter.

3. An optical wavelength multiplexer/demultiplexer according to claim 1 wherein:
said optical multiplexing/demultiplexing circuit is formed on a substrate;
said substrate having a slit groove formed therein along a direction across said optical output waveguides; and
at least one of said optical transmission filters is inserted into said slit groove.

4. An optical wavelength multiplexer/demultiplexer according to claim 3 wherein:
respective intersect angles between said slit groove and respective of the at least two optical output waveguides being different angles.

5. An optical wavelength multiplexer/demultiplexer according to claim 1 wherein:
said optical transmission filter being a grid-shaped wavelength filter having areas with different diffractive indexes formed in a periodic manner.

6. An optical wavelength multiplexer/demultiplexer according to claim 1 wherein:
said final stage is a third stage of a 1×8 optical wavelength multiplexer/demultiplexer.

7. An optical wavelength multiplexer/demultiplexer according to claim 1, wherein:
said plurality of directional coupling portions being two directional coupling portions.

8. An optical wavelength multiplexer/demultiplexer according to claim 1, wherein:
said plurality of directional coupling portions being three directional coupling portions.

9. An optical wavelength multiplexer/demultiplexer comprising:
an optical multiplexing/demultiplexing circuit that includes a Mach-Zehnder optical interferometer, said Mach-Zehnder optical interferometer being at least one stage and having a final stage, and including
a first optical waveguide,
a second optical waveguide arranged side-by-side with respect to said first optical waveguide, and
a plurality of multi-mode optical interference waveguides respectively formed where a portion of said first optical waveguide is located adjacent to and in proximity to a portion of said second optical waveguide for a predetermined interval along a longitudinal direction of both said first and second optical waveguides,
respective segments of the first optical waveguide and the second optical waveguide that are sandwiched between adjacent multi-mode optical interference waveguides having different lengths, the final stage having
at least two optical output waveguides, and
optical transmission filters provided in respective of the at least two optical output waveguides, said optical transmission filters being configured to transmit therethrough light having setting wavelengths determined in correspondence with wavelengths passed by the respective optical output waveguides.

10. An optical wavelength multiplexer/demultiplexer comprising:
an optical multiplexing/demultiplexing circuit that includes a Mach-Zehnder optical interferometer, said Mach-Zehnder optical interferometer being at least one stage and having a final stage, and including
a first optical waveguide,
a second optical waveguide arranged side-by-side with respect to said first optical waveguide,
a multi-mode optical interference waveguide, and
a directional coupling portion formed where a portion of said first optical waveguide is located adjacent to and in proximity to a portion of said second optical waveguide for a predetermined interval along a longitudinal direction of both said first and second optical waveguides,
respective segments of the first optical waveguide and the second optical waveguide being sandwiched between the directional coupling portion and the multi-mode optical interference waveguide having different lengths,
the final stage having
at least two optical output waveguides, and
optical transmission filters provided in respective of the at least two optical output waveguides, said optical transmission filters being configured to transmit therethrough light having setting wavelengths determined in correspondence with wavelengths passed by the respective optical output waveguides.

11. An optical wavelength multiplexer/demultiplexer according to claim 10, wherein:
said final stage is a third stage of a 1×8 optical wavelength multiplexer/demultiplexer.

12. An optical wavelength multiplexer/demultiplexer comprising:
an optical multiplexing/demultiplexing circuit that includes a Mach-Zehnder optical interferometer, said Mach-Zehnder optical interferometer being at least one stage and having a final stage, and including
a first optical waveguide,
a second optical waveguide arranged side-by-side with respect to said first optical waveguide, and
a plurality of a multi-mode optical interference waveguides,
respective segments of the first optical waveguide and the second optical waveguide being sandwiched between adjacent multi-mode optical interference waveguides having different lengths, the final stage having
at least two optical output waveguides, and
optical transmission filters provided in respective of the at least two optical output waveguides, said optical transmission filters being configured to transmit therethrough light having setting wavelengths determined in correspondence with wavelengths passed by the respective optical output waveguides.

13. An optical wavelength multiplexer/demultiplexer according to claim 12 wherein:
said final stage is a third stage of a 1×8 optical wavelength multiplexer/demultiplexer.

14. A method for using an optical wavelength multiplexer/demultiplexer having a Mach-Zehnder optical interferometer, comprising steps of:
passing a first light signal at a first wavelength and a second light signal at a second wavelength through a first optical waveguide;
coupling a portion of the second light signal into a second optical waveguide arranged side-by-side with respect to said first optical waveguide, said coupling step including
passing the second light signal through a plurality of directional coupling portions respectively formed where a portion of said first optical waveguide is located adjacent to and in proximity to a portion of said second optical waveguide for a predetermined interval along a longitudinal direction of both said first and second optical waveguides,
respective segments of the first optical waveguide and the second optical waveguide that are sandwiched between adjacent directional coupling portions having different lengths, and
filtering with a filter disposed in a final stage of the Mach-Zehnder optical interferometer the second signal light that is output from the first optical waveguide prior to passing said first light signal to an optical output waveguide; and
filtering with another filter disposed in the final stage of the Mach-Zehnder optical interferometer the first signal light that is output from the second optical waveguide prior to passing said second light signal to another optical output waveguide, so as to demultiplex the first optical signal and the second optical signal.

15. A method for using an optical wavelength multiplexer/demultiplexer having a Mach-Zehnder optical interferometer, with a final stage, comprising steps of:
inputting a first optical signal at a first wavelength to an optical output waveguide disposed in the final stage;
inputting a second optical signal at a first wavelength to another optical output waveguide disposed in the final stage;
filtering the first optical signal and the second optical signal with an optical transmission filter provided in the respective optical output waveguides, said optical transmission filter being configured to transmit therethrough light having respective wavelengths determined in correspondence with the respective optical output waveguides;
coupling at least a portion of the second light signal into a first optical waveguide, said coupling step including
passing the second light signal through a plurality of directional coupling portions respectively formed where a portion of said first optical waveguide is located adjacent to and in proximity to a portion of a second optical waveguide for a predetermined interval along a longitudinal direction of both said first and second optical waveguides,
respective segments of the first optical waveguide and the second optical waveguide that are sandwiched between adjacent directional coupling portions having different lengths, and
outputting the first light signal and the second light signal as a multiplexed signal through the first optical waveguide.

16. An optical wavelength multiplexer/demultiplexer comprising:
an optical multiplexing/demultiplexing circuit that includes a Mach-Zehnder optical interferometer, said Mach-Zehnder optical interferometer being at least one stage and having a final stage, and including
a first optical waveguide,
a second optical waveguide arranged side-by-side with respect to said first optical waveguide, and
a plurality of directional coupling portions respectively formed where a portion of said first optical waveguide is located adjacent to and in proximity to a portion of said second optical waveguide for a predetermined interval along a longitudinal direction of both said first and second optical waveguides,
respective segments of the first optical waveguide and the second optical waveguide that are sandwiched between adjacent directional coupling portions having different lengths, the final stage having
at least two optical output waveguides, and
gratings provided in respective of the at least two optical output waveguides, said fiber gratings being configured to transmit therethrough light having setting wavelengths determined in correspondence with wavelengths passed by the respective optical output waveguides.

17. An optical wavelength multiplexer/demultiplexer according to claim 16, wherein:
said gratings are Bragg gratings.
